(19) United States
(12) Patent Application Publication
(10) Pub. No.: US 2011/0113609 A1
(43) Pub. Date: May 19, 2011

(54) METHOD AND DEVICE FOR EXCHANGING A BATTERY IN A VEHICLE

(75) Inventors: PETER BERDELLE-HILGE, KONSTANZ (DE); HOLGER SCHERERZ, REHFELDE (DE); FRANK VOSS, BERLIN (DE)

(73) Assignee: SIEMENS AKTIENGESELLSCHAFT, MUENCHEN (DE)

(21) Appl. No.: 12/947,100

(22) Filed: Nov. 16, 2010

(30) Foreign Application Priority Data
Nov. 16, 2009 (DE) 10 2009 053 050.9

(51) Int. Cl. B60S 5/06; B23P 19/00

(52) U.S. Cl. 29/426.1; 29/762

(57) ABSTRACT

A method and a device for exchanging a battery of a vehicle, in particular of an electric car. The battery is connected to the vehicle by way of at least one mechanical fastening element and one electrical connection element. The vehicle is brought into a position in relation to a lift table located below the vehicle. The lift table is raised. At least one imaging device connected to the lift table produces at least one vehicle image. The vehicle image shows the battery in the vehicle before removal. A decision of good or bad in relation to the current state of the element is taken in each case by evaluating the vehicle image(s) for each fastening element and each connection element. In one refinement, the vehicle image is displayed on a video display unit, and an input of a user relating to the vehicle image is acquired.

### CROSS-REFERENCE TO RELATED APPLICATION

This application claims the priority, under 35 U.S.C. §119, of German patent application DE 10 2009 053 050.9, filed Nov. 16, 2009; the prior application is herewith incorporated by reference in its entirety.

### BACKGROUND OF THE INVENTION

### Field of the Invention

The invention relates to a method and a device for exchanging a battery in a vehicle, in particular in an electric car.

International patent application publication WO 2009/039454 A1 describes a method for charging the batteries of electric vehicles. The current status of a battery in a vehicle is determined. Furthermore, it is determined where the vehicle is currently located. If the battery must be charged or replaced, a charging station that can still be reached is displayed for a driver of the vehicle. In one refinement, the at least partially discharged battery is not charged in the vehicle, but removed and replaced by a new, already charged battery.

### SUMMARY OF THE INVENTION

It is accordingly an object of the invention to provide a method of exchanging batteries in a vehicle and battery exchange station which overcome the above-mentioned disadvantages of the heretofore-known devices and methods of this general type and which provide for method and a device that enable a quick and efficient exchange of a battery in a vehicle.

With the foregoing and other objects in view there is provided, in accordance with the invention, a method of removing a battery from a vehicle, wherein the battery is mechanically connected to the vehicle by way of at least one fastening element and electrically connected by way of at least one connection element. The method comprises the following steps:

causing the vehicle to be brought into a position relative to a lift table below the vehicle;

raising the lift table;

producing at least one vehicle image with at least one imaging device connected to the lift table, the at least one vehicle image showing the battery in the vehicle prior to removal; and

evaluating the at least one vehicle image and rendering a decision of good or bad concerning a current state of each fastening element and each connection element.

The exchange of the battery by a movement downward is the quickest and most efficient way of taking the old battery out of the vehicle and installing a new battery.

With the above and other objects in view there is also provided, in accordance with the invention, a device for removing a battery from a vehicle, wherein the battery is mechanically connected to the vehicle by way of at least one fastening element and electrically connected by way of a connection element.

The novel battery changing device comprises:

a lift table and at least one actuator for said lift table;

at least one changing tool mechanically connected to said lift table;

a regulator for driving said at least one actuator; and

at least one imaging device.

The device is configured to carry out the following processing steps:

causing the vehicle to be brought into a position where said lift table is located below the vehicle;

raising the lift table;

producing at least one vehicle image by way of said imaging device, with the at least one vehicle image showing the battery in the vehicle prior to removal; and

evaluating the at least one vehicle image for each fastening element and each connection element and taking a decision of good or bad in relation to a current state of the respective element.

In other words, the objects of the invention are achieved in that at least one vehicle image is evaluated. Here, each mechanical fastening element and each electrical connection element is checked. A decision as to whether the element is intact or defective is taken for each fastening element and each connection element. Because initially this decision is taken for each element, it is impossible to start removing the battery even though a fastening element or a connection element is defective. Consequently, unnecessary delays in the process are prevented. Rather, a decision is firstly taken as to whether the battery may be removed without further steps, or not.

In one refinement, the at least one vehicle image is transmitted to an image evaluation device that automatically evaluates the vehicle image, and automatically takes each decision of good or bad. This refinement saves time because of the automation effected.

In another refinement, the at least one vehicle image is transmitted to a video display unit or display unit (short: VDU) workstation and displayed there on a display. A processing person tests the displayed vehicle image and respectively undertakes one input per fastening element and per connection element. The in each case one input is acquired and evaluated. It is also possible for a processing person to undertake a single overall decision of good or bad for the overall vehicle image, and to input a corresponding input. This one decision taken is then valid for each element.

This refinement enables someone engaged in processing, for example a mechanic, to examine the battery to be removed without having to be on site. A mechanic can thereby monitor a plurality of battery changing stations in a time overlapping fashion, or monitor these stations one after another and thereby save traveling time. The mechanic can work in a more ergonomic position than under a vehicle and be in more pleasant surroundings.

Also possible is a mixed form: firstly, the image evaluation unit automatically attempts to take a decision for each connection element and each fastening element. If the image evaluation unit fails to do so for at least one element, the at least one vehicle image is transmitted to the VDU workstation and displayed there. The image evaluation unit in each case preferably calculates a safety measure for each decision of good or bad. If this safety measure is below a prescribed bound, the vehicle image is transmitted to the VDU workstation.

It is also possible for the at least one vehicle image to be transmitted to the VDU workstation and displayed on the VDU whenever the image evaluation unit has taken a decision of bad for at least one element or a decision with a safety measure smaller than the bound. Otherwise, it is the decision taken automatically and with sufficient safety that is used.

Other features which are considered as characteristic for the invention are set forth in the appended claims.

Although the invention is illustrated and described herein as embodied in a method and device for exchanging a battery in a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic side view of a battery changing station in an exemplary embodiment of the invention;

FIG. 2 is a similar view showing the first step of a sequence, in the first step the old battery still being located in the vehicle and the lift table being located below the old battery;

FIG. 3 is a similar view showing the next step of the sequence, the lift table having lowered the old battery down;

FIG. 4 is a similar view showing the next step of the sequence, the lift table with the old, removed battery having been moved away to the side; and

FIG. 5, again in a side view, illustrates the next step of the sequence, the lift table having raised the removed battery.

### DETAILED DESCRIPTION OF THE INVENTION

In the exemplary embodiment, the invention is used to exchange in a fully automated fashion a battery that is installed in a road vehicle. In the exemplary embodiment, this road vehicle has an electric drive. In one refinement, the discharged or defective battery is exchanged when it is discharged, and replaced by a charged battery. This refinement has the advantage that the vehicle is available while the discharged battery is being recharged. In another refinement, the battery is replaced because the old battery is defective.

The discharged or defective battery is denoted below as the “old battery,” and the charged and intact battery is denoted as the “new battery.”

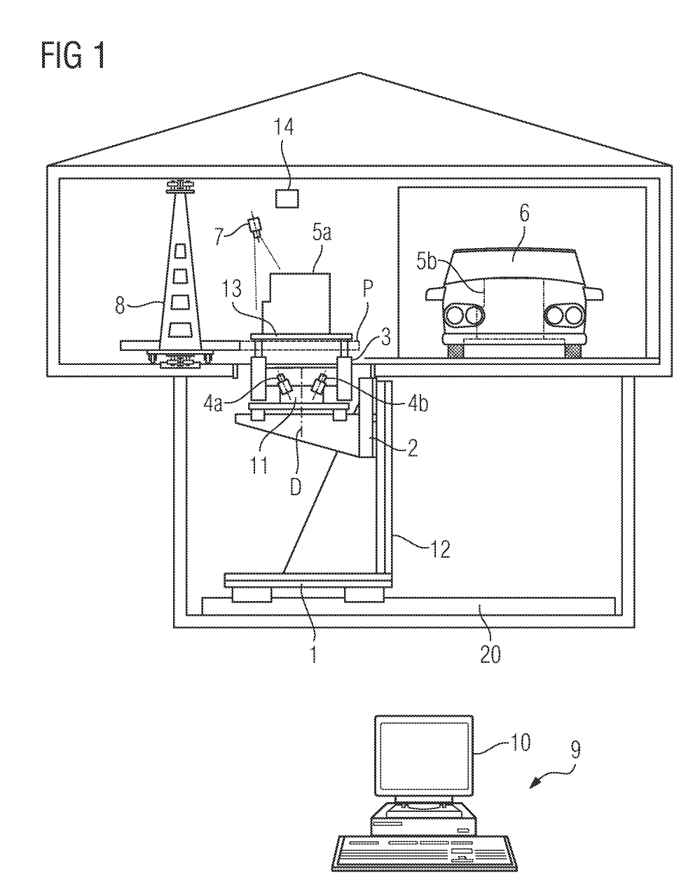

Referring now to the figures of the drawing in detail and first, particularly, to FIG. 1 thereof, there is shown the battery changing station of the exemplary embodiment. The following are illustrated:
a lift table 2 with a bearing surface 13,
a holding device 1 for the lift table 2,
it being possible for the holding device 1 to be displaced horizontally on a guide device 20,
a bearing surface actuator 3 that is able to move the bearing surface 13 up and down in relation to the rest of the lift table 2,
a lift table actuator 12 that is able to move the lift table 2 up and down in relation to the holding device 1,
a conveyor device 8 for in each case one battery that is able to move up into a position P below the bearing surface 13,
two cameras 4a, 4b that are mechanically connected to the lift table 2 and are moved up and down together with the lift table 2,
a camera 7 mounted in a stationary fashion,
a closed-loop control system 11 (short: regulator 11) for the lift table 2, and
an image evaluation unit 14.

The image evaluation unit 14 is connected by data connections to the cameras 4a, 4b, 7 and to the regulator 11.

Also to be seen in FIG. 1 is a vehicle 6 with an old battery 5a. A VDU workstation 9 with a VDU 10 is located remote from the battery changing station. The VDU workstation 9 is connected by data connections to the cameras 4a, 4b, 7 of the image evaluation unit 14, and to the regulator 11.

The discharged battery 5a is removed from the vehicle 6 from below, and the new battery is inserted from below. It is possible to raise the vehicle 6 for this purpose. However, the vehicle 6 is preferably positioned above a space that is open at the top and extends below a floor.

A lift table 2 with changing tools moves under the battery from below. The changing tools release the battery 5a from its holder in the vehicle 6. The lift table 2 is lowered down and takes the old battery 5a downward from the vehicle 6. A conveyor device 8 transports the old battery 5a away. This conveyor device 8 is located in the open space under the vehicle 6 or next to the vehicle 6. Subsequently, the conveyor device 8 transports a new battery to the lift table 2. The lift table 2 raises the new battery until the new battery has reached the correct position in the vehicle 6. The changing tools fasten the new battery at its place in the vehicle 6.

These steps are to be carried out in an automated fashion. In order to enable this, the lift table 2 can be moved linearly up and down vertically and in relation to the holding device 1. The bearing surface 13 can be moved up and down in relation to the remainder of the lift table 2. In one refinement, the lift table 2 can be moved linearly in all three directions of a Cartesian coordinate system. Moreover, in one refinement the lift table 2 can rotate about at least one vertical rotation axis D. The lift table 2 has corresponding actuators 3, 12.

The changing tools are mechanically connected to the lift table 2 and displaced together with the lift table 2. It is also possible for a changing tool to be displaced in relation to the lift table 2 as well by means of a tool actuator, in particular to rotate about a rotation axis and/or to move linearly. In one refinement, at least one changing tool can be brought into each position relative to the lift table 2 within a region. The lift table 2 has corresponding actuators for moving a changing tool in relation to the lift table 2.

The device according to the embodiment has a sensor system and a regulator 11.

The regulator 11 is a closed-loop control system that processes measured values of the sensor system and controls the actuators 3, 12 of the lift table 2 and of the changing tools.

The sensor system comprises at least a lift table camera 4a, 4b, a distance sensor and an image evaluation unit 14. The at least one lift table camera 4a, 4b is permanently connected to the lift table 2 and is moved together with the lift table 2. Each lift table camera 4a, 4b produces images in a viewing direction that is perpendicular or obliquely upward.

In one refinement, the lift table 2 has a plurality of lift table cameras 4a, 4b. This plurality of cameras 4a, 4b produces images from various viewing directions.

It is also possible for a further camera to be present that is mounted in a stationary fashion. Such a stationary camera 7 is shown in FIG. 1.

If a changing tool can be moved in relation to the lift table 2, the sensor system then preferably moreover comprises a tool camera that is connected to the changing tool and is moved in relation to the lift table 2 together with the changing tool.

The sensor system preferably further has at least one distance sensor. This distance sensor is capable of measuring the distance between the lift table 2 or a changing tool on the lift table 2 and the vehicle 6.

The vehicle 6 is firstly positioned in a specific start position above the lift table 2. This step can be carried out by a driver who brings the vehicle 6 into the start position.

The lift table 2 is subsequently moved into a specific position in relation to the old battery 5a, which is still installed. For this purpose, a prominent reference element, optically detectable from below, of the vehicle 6 or of the old battery 5a is prescribed and used. This reference element marks the position of the battery 5a inside the vehicle 6.

The reference element is, for example, an optically detectable identifier for the old battery 5a that distinguishes this battery 5a from all the other batteries that are in use in vehicles in the catchment area of the battery changing station. The identifier is, for example, coded in the form of a barcode and/or placed on the battery 5a in plain text.

The following sequence is carried out at least once:
At least one lift table camera 4a, 4b produces at least one vehicle image from below in an imaging direction that is perpendicular or obliquely upward.
The image evaluation unit 14 evaluates the at least one vehicle image and searches in the vehicle image for an image of the reference element. For this purpose, either the image evaluation unit 14 compares the reference element image with an electronic library of images, or the image evaluation unit 14 evaluates the vehicle image by applying prescribed rules.
If the lift table 2 already has the correct prescribed position in relation to the reference element, the image of the reference element is located at a specific position in the vehicle image. “Correct” means that: the deviation of the actual relative position from the desired relative position is within a prescribed tolerance. This tolerance is a function of the radius of action of the changing tool in relation to the lift table. The larger this radius of action, the larger, too, is the tolerance. The image evaluation unit 14 automatically checks whether the lift table 2 has the correct prescribed relative position.
Otherwise, the image evaluation unit 14 determines the actual position and the deviation of the actual position from the desired position (distance, direction) of the reference element image in the vehicle image, and transmits the deviation to the regulator 11.
The regulator 11 calculates positioning commands for the actuators 3, 12 of the lift table 2 from the transmitted deviation.
These positioning commands are transmitted to the actuators 3, 12.
The actuators 3, 12 move the lift table 2 and/or the bearing surface 13 in accordance with the transmitted positioning commands.
The sequence is carried out again once.

It follows that in this refinement the lift table 2 is moved in relation to the vehicle 6, specifically is rotated and/or moved linearly in a direction that has a horizontal directional component. The lift table 2 is therefore not only raised, but also moved to the side.

In an alternative refinement, the lift table 2 and/or the bearing surface 13 need only have one actuator in each case that is capable of moving the lift table 2 up and down. For this purpose, the vehicle 6 can be moved in a horizontal plane, for example with the aid of a lifting platform or of a carriage that has an actuator. The regulator 11 transmits its positioning commands to said drive, and the vehicle 6 is moved in a horizontal direction in accordance with the positioning commands.

It is possible for the vehicle 6 already to be located at the correct position in relation to the lift table 2 whenever it has been brought into the start position, that is to say the actual relative position deviates from the desired relative position by no more than the tolerance. This is checked by evaluating the vehicle image, specifically via the image evaluation unit 14. In this case, neither the vehicle 6 nor the lift table 2 need be moved in a horizontal direction or rotated.

After this sequence or these sequences have been carried out, the lift table 2 is located at a prescribed desired relative position in relation to the vehicle 6 and below the vehicle 6.

The actuators 3, 12 move the lift table 2 vertically upward and move the bearing surface 13 in relation to the lift table 2. The at least one distance sensor measures the distance of the lift table 2 with the changing tools in relation to the vehicle 6. If this measured distance undershoots a prescribed bound, the lift table 2 is stopped in order to avoid damage to the lift table 2 or to the vehicle 6.

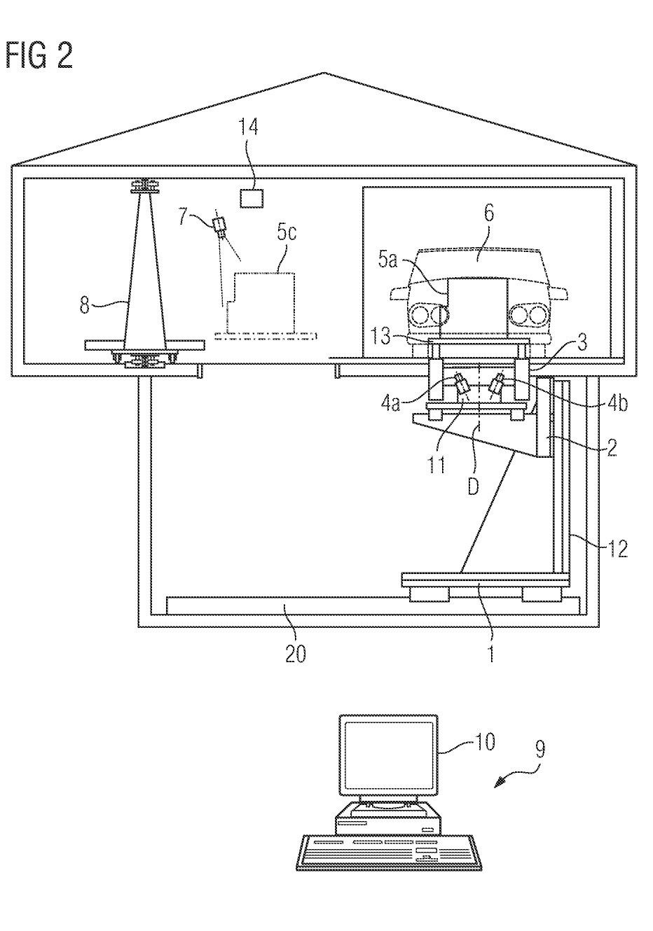

FIG. 2 shows the situation where the old battery 5a is still located in the vehicle 6, and the lift table 2 is raised as far as below the old battery 5a. The old battery 5a is already resting on the bearing surface 13. The changing tools can now release the fastening elements.

It is possible for the following two cycles to be carried out in a fashion overlapping in time:
The lift table 2 or the vehicle 6 is moved in order to produce the prescribed actual relative position.
The lift table 2 is raised, that is to say moved upward in the vertical direction.

The changing tools have now been brought into a position on the lift table 2 in which the changing tools can access the old battery 5a from below in order to remove the old battery 5a from the vehicle 6.

The old battery 5a is fastened on the vehicle 6 by means of at least one, preferably a plurality of, mechanical fastening elements. Such a fastening element is, for example, configured as a bayonet screw. Moreover, the old battery 5a is connected to the rest of the vehicle 6 by a plurality of electrical connection elements.

In one embodiment, it is firstly checked whether the old battery 5a can be replaced by a new battery automatically and without additional steps, or whether this step cannot be carried out because the current state of the fastening elements does not enable this, for example because the fastening elements are mechanically damaged or corroded, or the changing tools do not reach a fastening element because another element of the vehicle 6 or contamination blocks safe access. It is also possible that an electrical connection element is contaminated or corroded or mechanically damaged. In this case, as well, the old battery 5a cannot be removed without further steps, for example because damage owing to a short circuit is to be avoided.

In order to check this, a further image of the old battery 5a, which is still fastened in the vehicle 6, and of the fastening elements is produced, specifically by a camera 4a, 4b of the positioned lift table 2. This battery image is transmitted to the image evaluation unit 14. The image evaluation unit 14 searches in the image for the fastening elements, for example the image evaluation unit 14 to this end searching through an electronic library with reference images of fastening elements, or applying prescribed rules. The image evaluation unit 14 evaluates the images of the fastening elements and automatically takes a decision as to whether the battery can be released.

In one refinement, the optically detectable identifier of the old battery 5a is deciphered in the vehicle image, for example by reading and decoding the barcode. A decision computer of the battery changing station is connected to a central database for batteries. A data record is respectively stored in this central database for each battery used. This data record includes the battery identifier and details relating to the date of manufacture and relating to the times when the battery 5a has already been charged and to the times when it has been cleaned or repaired. The decision computer directs a query to a server of this central database. The query covers the battery identifier. In answer to this query, the database server supplies the date of manufacture and the times of charging, cleaning and repair of the old battery 5a. The decision computer evaluates the answer and automatically takes a decision as to whether the fastening elements and connection elements therefore already need to be manually checked because the old battery 5a has anyway already been in use for a long time or because it has already been used in the same vehicle for a long time. The decision of the image evaluation unit 14 or of the decision computer is associated in terms of one refinement with a safety measure. The image evaluation unit 14 calculates this safety measure. If the safety measure is less than a prescribed safety bound, the image evaluation unit 14 automatically infers that a decision cannot be taken automatically.

The at least one vehicle image of the vehicle 6 with the battery 5a still installed is transmitted to a VDU workstation 9 and displayed on a VDU 10 of the VDU workstation 9. The VDU workstation 9 has a data processing system which includes the VDU 10 and suitable input devices and control elements.

This VDU workstation 9 is preferably set up ergonomically and is located outside the space under the vehicle 6. In one refinement, the VDU workstation 9 is located at a location other than the battery changing station with the open space. It is possible for a plurality of battery changing stations to be connected to the same VDU workstation 9.

A processing person, for example a mechanic, analyzes the at least one vehicle image. In one refinement, this processing person monitors a plurality of battery changing stations.

The processing person makes a decision, preferably between one of the following alternatives:
The old battery 5a can be automatically removed by the available changing tools.
The old battery 5a can be removed only manually.

In one refinement, the mechanic additionally decides whether there is a need to supply the battery changing station with a further changing tool.

This decision is input into a suitable input device by the mechanic. The data processing system of the VDU workstation 9 acquires each input from the user, that is to say the mechanic, and evaluates this input. Signals with the evaluated user inputs are transmitted to the regulator 11.

In one refinement, the image evaluation unit 14 respectively calculates for each fastening element and each connection element a safety measure for the decision of good or bad, which is automatically taken. The VDU 10 displays each fastening element and each connection element that the image evaluation unit 14 has detected in the images. The fastening elements and connection elements with a small safety measure, and the fastening elements and connection elements for which the image evaluation unit 14 has taken a decision of bad are highlighted. The processing person marks a displayed element or selects the displayed element in another way, and inputs his decision relating to this element. The decision of the processing person overwrites a decision of the image evaluation unit 14 that has been taken automatically.

In another refinement, the vehicle image is displayed on the VDU 10 only when the image evaluation unit 14 has taken a decision of bad or has calculated a small safety measure for a decision. A processing person analyzes this at least one vehicle image with the old battery 5a that is still installed, and takes a decision of good or bad for the entire battery 5a. This overall decision is acquired and evaluated.

In a further refinement, the image evaluation unit 14 is saved. Each vehicle image is transmitted to the VDU workstation 9 without a prior automatic evaluation, and displayed on the VDU 10.

The VDU workstation 9 preferably has control elements with which the mechanic can actuate the lift table camera 4a, 4b, and can, for example, vary the viewing direction, the subject area shown and the viewing angle. The person processing takes a decision of good or bad for the entire battery 5a.

In one refinement, the battery is automatically removed when a decision of good has been taken for each fastening element and each connection element. Subsequently, at least one further vehicle image is produced that shows the region of the vehicle where the battery was situated before removal. This at least one further vehicle image is evaluated in order to analyze the fastening elements and connection elements, and in each case to make a decision of good or bad again. This decision can be taken with relatively high reliability with the battery removed, because the fastening elements and connection elements of the vehicle can be seen more effectively than with the battery installed. A new battery is preferably installed only when a decision of good has been taken for each connection element and each fastening element with the battery removed.

In one refinement, the further vehicle image is also transmitted to a VDU workstation 9 and displayed there on a VDU 10, and a decision is taken in each case by a processing person. Described below are the next steps, which are carried out in the case when the image evaluation unit 14 has taken the decision that the old battery 5a can be automatically removed, or the VDU workstation 9 has acquired such a decision by the mechanic.
The image evaluation unit 14 determines which fastening elements are holding the old battery 5a, and transmits a corresponding signal to the regulator 11.
A sequence is repeatedly carried out for each fastening element in order to regulate a changing tool into a position where the changing tool can release this fastening element.

In one refinement, the lift table 2 has at least one tool actuator for rotating a changing tool relative to the lift table, and/or for moving it linearly. The regulator 11 transmits positioning commands to this tool actuator, and receives check-back signals from this tool actuator. The regulator 11 therefore “knows” at any time the position of the changing tool in relation to the lift table.

In this refinement, a sequence comprising the following steps is carried out:
A lift table camera 4a, 4b or else the tool camera produces an image of the old battery 5a and of the fastening element.
The image evaluation unit 14 evaluates the image and determines the actual position of the fastening element image in the image of the battery 5a.
If there is no image of the fastening element in the battery image, the lift table 2 or the vehicle 6 is moved, and subsequently a further image of the old battery 5a is produced together with the fastening element.
After the image evaluation unit 14 has determined the actual position of the fastening element image in the battery image, the image evaluation unit 14 transmits corresponding signals describing this actual position to the regulator 11.
The regulator 11 evaluates these signals and the signals relating to the current position of the changing tool, and produces positioning commands for the tool actuator.
The tool actuator moves the changing tool into a desired position relative to the fastening element such that the changing tool can grip the fastening element.

The changing tool preferably has a tactile sensor. This tactile sensor measures whether the changing tool was able to grip the fastening element or not. The tactile sensor produces a check-back signal to the regulator 11, and the regulator 11 assesses this check-back signal in order, if necessary, to produce further positioning commands for the tool actuator.

When there is a fault signal from the sensor of the changing tool, or else in any case, a further image of the old battery 5a with the fastening element is produced. Because the changing tool is now located in the vicinity of the fastening element, the vehicle image additionally shows the changing tool. The image evaluation unit 14 evaluates this image and searches for images of the changing tool and of the fastening element. The image evaluation unit 14 produces signals with the actual position of the changing tool in the image in the battery image. The regulator 11 evaluates these signals and, if necessary, produces further positioning commands for the tool actuator.

Each lift table camera 4a, 4b preferably respectively produces at each recording instant a picture in a viewing direction that is perpendicular or obliquely upward. This is true for the lift table camera and, if appropriate, for a camera 7 mounted in a stationary fashion. The image evaluation unit 14 evaluates this plurality of pictures produced at the same time.

In one refinement, the or each lift table camera 4a, 4b is permanently connected to the lift table 2. In one modification, the lift table 2 additionally has at least one camera actuator. The regulator 11 additionally drives this camera actuator in order to bring the camera 4a, 4b into another position in relation to the lift table 2, and thus also in relation to the fastening element. This variation in position is carried out whenever the image evaluation unit 14 has not discovered any holding element image in an image of the battery, for example because the changing tool is covering the fastening element—seen in the previous viewing direction.

In one refinement, the vehicle images are transmitted, in turn, from the lift table camera 4a, 4b to the VDU workstation 9 and displayed on the VDU 10. The mechanic monitors the replacement of the battery 5a. The VDU workstation 9 preferably has an emergency stop control element with the aid of which the mechanic can stop the lift table 2 with the changing tools.

The changing tools successively release the fastening elements. While these steps are being carried out, the old battery 5a is preferably standing on the bearing surface 13 of the lift table 2.

In the image(s) of the battery 5a, the image evaluation unit 14 has determined the position of each fastening element and transmitted corresponding signals to the regulator 11. The regulator therefore “knows” how many fastening elements are to be released overall. After a changing tool has released a fastening element, the changing tool preferably sends a check-back signal to the regulator 11. The regulator 11 evaluates this check-back signal and tests whether all the fastening elements have now been released, or whether there is now still a further fastening element to be released. As soon as all the fastening elements have been released, the regulator 11 sends a corresponding signal to the lift table 2. The lift table 2 lowers the released old battery 5a down, and removes it thereby from the vehicle 6. The lift table 2 lowers the old battery 5a down as far as the conveyor device 8. A conveyor belt of the lift table 2, or else a manipulating device displaces the old battery 5a onto the conveyor device 8. The conveyor device 8 transports the old battery 5a away.

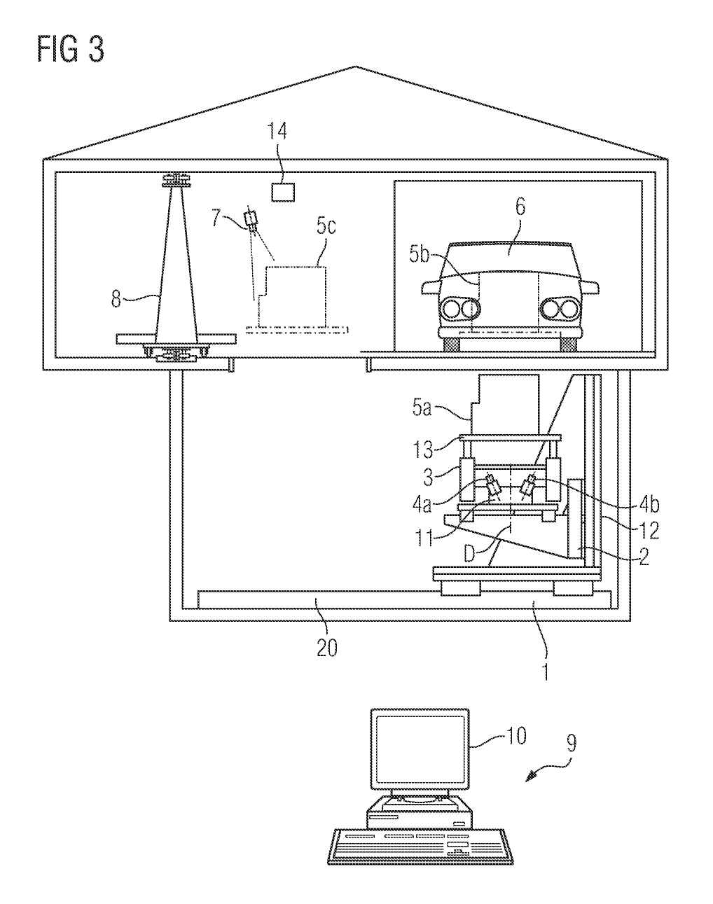

FIG. 3 shows the situation in which the lift table 2 has lowered the old battery 5a down. The free space 5b in the vehicle 6 can be seen.

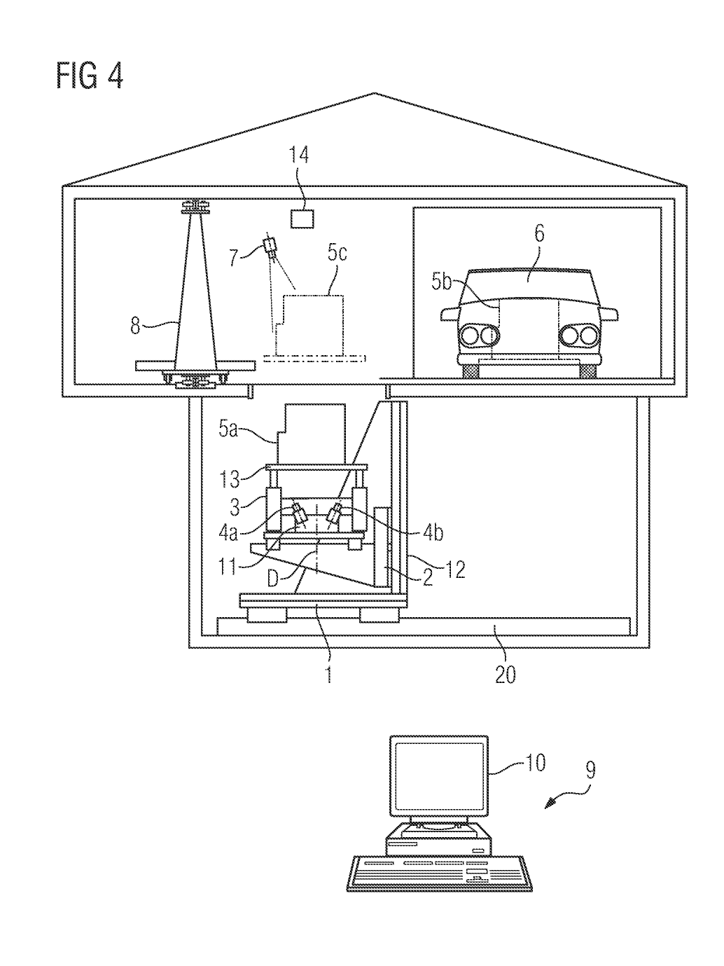

FIG. 4 shows the situation in which the lift table 2 that has been lowered down has been moved to the side. The holding device 1 with the lift table 2 is moved to the side on a guide device 20.

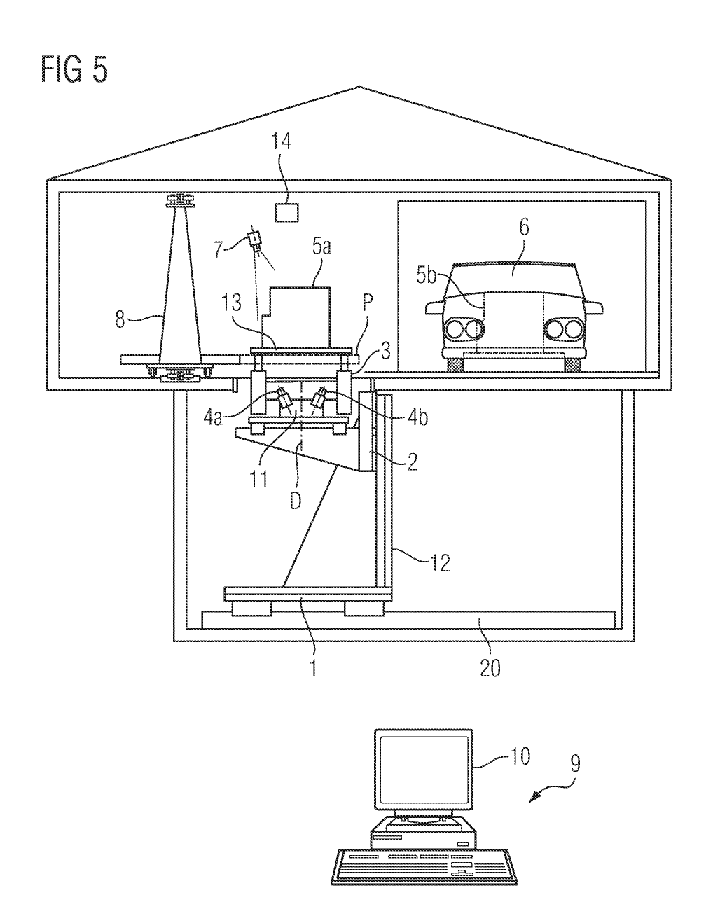

FIG. 5 shows the situation in which the lift table 2 has raised the old battery 5a. The conveyor device 8 is now able to transport the old battery 5a away to a charging station.

In one refinement, the cameras 4a, 4b, 7 respectively produce individual images of the vehicle 6 or of the battery 5a. In a preferred refinement, at least one camera is configured as a video camera that produces images permanently. This sequence of images is transmitted to the VDU workstation 9. A sequence of images is displayed on the VDU 10. The distance in time between two consecutive pictures is preferably so small that a mechanic sees a film without jittering on the VDU 10.

The at least one video camera is preferably configured with a camera actuator and with a zoom. The mechanic can drive said actuator and said zoom via control elements. The mechanic can therefore change the viewing direction, the subject area and the viewing angle of the video camera, and thereby monitor the removal of the old battery and the installation of the new one continuously, specifically virtually without a time delay. Said control elements are also already available to the mechanic for checking the still installed battery in more detail, for example in order to move a camera 4a, 4b in relation to the lift table and thereby to change the subject area and the viewing angle or the viewing direction. It is only the short period required for data transmission and displaying images that elapses between a real event in the battery changing station and the display of this event on the VDU 10.

In the embodiment so far represented, the actuators for the bearing surface 13, 12 for the lift table 2, and, if appropriate, the actuators for the changing tools are driven automatically by the regulator 11 in cooperation with the image evaluation unit 14. In a variant embodiment, the VDU workstation 9 comprises a plurality of control elements for the purpose of driving the actuators 3, 12 for the lift table and for the changing tools. A mechanic at the VDU workstation 9 can take over the control of an actuator 3, 12 at any time and himself produce positioning commands to said actuator 3, 12. For example, the mechanic actuates a joystick or a control stick or a control wheel.

In one refinement, the lift table 2 with the cameras 4a, 4b is raised anew after the old battery 5a has been removed and lowered down. At least one camera 4a, 4b produces at least one image of the mechanical fastening elements and electrical connection elements. The fastening elements and connection elements can be detected more effectively in this image than in an image with the old battery 5a, because now no battery covers the fastening elements and connection elements.

The image evaluation unit 14 evaluates the at least one image in order to check whether all the fastening elements and connection elements of the vehicle 6 are intact, or whether a fastening element or connection element is, for example, mechanically damaged, contaminated or corroded. The image evaluation unit 14 takes a corresponding decision. The image evaluation unit 14 preferably additionally calculates a safety measure, in turn. If the image evaluation unit 14 decides that a fastening element or connection element is defective or contaminated, or if the calculated safety measure remains below a prescribed bound, the at least one image is transmitted in turn to a VDU workstation 9 and displayed on the VDU 10. A mechanic decides whether repairs or cleaning work are required on the vehicle 6 and, if they are, which ones. The mechanic decides if necessary which repair steps are to be carried out. The mechanic analyzes the displayed image for this purpose.

It is preferred in turn for at least one video camera to transmit images permanently from the vehicle 6 without battery 5a to the VDU workstation 9, and for a sequence to be displayed on the VDU 10, which appears as a film to the mechanic. The mechanic can change the viewing direction, the subject area and/or the viewing angle by means of suitable control elements.

If all the connection elements and fastening elements are intact, a new battery is installed in the vehicle 6. For this purpose, a new battery is taken onto the conveyor device 8, or linked to the conveyor device 8 temporarily in another way. The conveyor device 8 transports the new battery to the lift table 2. The new battery is taken onto the lift table 2. The lift table 2 with the new battery is raised. The lift table 2 positions the battery in the correct position with reference to the fastening elements and connection elements. In this process, images are recorded and evaluated in turn, and the position of the lift table 2 is varied in a targeted fashion by regulation. The changing tools subsequently mount the new battery permanently on the fastening elements in the vehicle 6. Images are produced and evaluated in turn, and the positions of changing tools relative to the lift table 2 are varied by targeted regulation. The locking element is locked after the new battery has been installed. This terminates the exchange of the battery. The lift table 2 is lowered down again, and the vehicle 6 is driven off.

The old battery 5a is transported to a testing station with a further camera. In one refinement, the stationary camera 7 belongs to this battery testing station. In one refinement, at least one image of the removed old battery 5a is firstly produced. This battery image shows the fastening elements and connection elements of the old battery 5a. Because the image shows the removed old battery 5a, the fastening elements and connection elements can be more effectively detected than in the case of an installed battery.

The image evaluation unit 14 evaluates the at least one image of the old, removed battery 5a and firstly attempts automatically to decide whether the old battery 5a can be recharged and installed without additional steps. For this purpose, the image evaluation unit 14 evaluates the images of the fastening elements and connection elements in the battery image, and determines the respective current state of the element. In particular, the image evaluation unit 14 searches for indications of mechanical damage, contamination and traces of corrosion. The image evaluation unit 14 preferably calculates a safety measure for this decision, in turn.

If the image evaluation unit 14 decides that an electrical connection element is defective or corroded or contaminated, or if the safety measure lies below a prescribed bound, the image is transmitted to the VDU workstation 9 again, and displayed on the VDU 10. A mechanic analyzes the image more accurately and takes a decision as to what is to happen with the old battery 5a.

In one refinement, at least one battery image of the removed battery 5a is produced. A decision of good or bad is taken for each fastening element and each connection element of the removed battery. Either this decision is taken in turn automatically via an image evaluation unit 14, or the battery image is displayed on the VDU of the VDU workstation 9, and at least one input from a mechanic is acquired. Only once a decision of good has been taken for each fastening element and connection element is the removed battery 5a charged. This prevents a contaminated, corroded or mechanically damaged battery from being superfluously transported into a charging station, and also prevents a vain attempt being made there to charge the battery, causing superfluous blocking of the charging station.

By way of example, the mechanic decides between the following alternatives:
The old battery 5a can be recharged and installed without additional steps.
The old battery 5a must be examined manually in situ.
The old battery 5a needs to be cleaned.
The old battery 5a needs to be repaired.
The old battery 5a must be disposed of.

Otherwise, that is to say given exclusively intact connection elements, the old battery 5a is transported to the charging station and charged there.

The mechanic at the VDU workstation 9 is thereby enabled to examine both a still installed old battery 5a and the removed old battery 5a thoroughly from a distance before he decides whether a new battery can be installed automatically or manually, and whether the old battery 5a can be reused.

The following is a list of reference numerals used in this specification, for easy reference:

### REFERENCE MEANING

1 Holding device for the lift table 2
2 Lift table
3 Actuator for the bearing surface 13
4a, 4b Cameras on the lift table 2
5a Battery
5b Space in the vehicle 6 in which the battery 5a is to be installed
6 Vehicle
7 Additional camera, mounted in a stationary fashion, for images from another viewing direction than the cameras 4a, 4b
8 Conveyor device for batteries
9 VDU workstation
10 VDU of the VDU workstation 9
11 Regulator for driving the actuators 3, 12
12 Actuator for the lift table 2
13 Bearing surface of the lift table 2
14 Image evaluation unit
20 Guide rail for the holding device 1

1. A method of removing a battery from a vehicle, wherein the battery is mechanically connected to the vehicle by way of at least one fastening element and electrically connected by way of at least one connection element, the method which comprises the following steps:
causing the vehicle to be brought into a position relative to a lift table below the vehicle;
raising the lift table;
producing at least one vehicle image with at least one imaging device connected to the lift table, the at least one vehicle image showing the battery in the vehicle prior to removal; and
evaluating the at least one vehicle image and rendering a decision of good or bad concerning a current state of each fastening element and each connection element.

2. The method according to claim 1, wherein the evaluating step comprises:
transmitting the image to a data processing system having a display device;
displaying the image with the VDU; and
acquiring and evaluating with the data processing system at least one input relating to the current state of a respective connection element or fastening element being displayed.

3. The method according to claim 2, wherein:
the data processing system tests whether a single decision of good has been taken for the battery with all the fastening elements and connection elements, and
if an overall decision of good has been taken, using the one overall decision of good as a decision of good for each fastening element and for each connection element.

4. The method according to claim 1, which comprises:
whenever a decision of good has been taken for each fastening element and connection element, carrying out the following additional steps:
releasing each fastening element with at least one changing tool mechanically connected to the lift table; and
lowering the lift table with the battery.

5. The method according to claim 4, which further comprises:
generating at least one further vehicle image after removal of the battery, the further vehicle image showing a region of the vehicle in which the battery was located prior to removal;
taking a decision of good or bad relative to the current state of each holding element and each connection element by evaluating the at least one further vehicle image for each holding element and connection element; and
if a decision of good has been taken upon renewed decision for each fastening element and connection element, carrying out the following additional steps:
placing a new battery onto the lift table;
raising the lift table together with the new battery; and
installing the new battery with the at least one changing tool by fastening each fastening element with the changing tool.

6. The method according to claim 1, which comprises:
producing at least one battery image showing the battery after the removal from the vehicle; and
evaluating the at least one battery image and taking a decision of good or bad concerning a current state of the battery.

7. A device for removing a battery from a vehicle, wherein the battery is mechanically connected to the vehicle by way of at least one fastening element and electrically connected by way of a connection element, the battery changing device comprising:
a lift table and at least one actuator for said lift table;
at least one changing tool mechanically connected to said lift table;
a regulator for driving said at least one actuator; and
at least one imaging device; and
the device being configured to carry out the following processing steps:
causing the vehicle to be brought into a position where said lift table is located below the vehicle;
raising the lift table;
producing at least one vehicle image by way of said imaging device, with the at least one vehicle image showing the battery in the vehicle prior to removal; and
evaluating the at least one vehicle image for each fastening element and each connection element and taking a decision of good or bad in relation to a current state of the respective element.

8. The device according to claim 7,
which further comprises a VDU workstation having a data processing system having a display unit and at least one input device;
said data processing system being connected to said at least one imaging device and being configured to display on said display unit a vehicle image that has been produced by said imaging device; and
said input device being configured to acquire at least one input in relation to a current state of a respectively displayed connection element or fastening element.
